(19) United States
(12) Patent Application Publication
(10) Pub. No.: US 2004/0256458 A1
(43) Pub. Date: Dec. 23, 2004

(54) Decoding system and method for using same

(76) Inventor: Gene S. Rosner, Marengo, IL (US)

Correspondence Address: PATENT ADMINSTRATOR, KATTEN MUCHIN ZAVIS ROSENMAN, 525 WEST MONROE STREET, SUITE 1600, CHICAGO, IL, 60661-3693, US

(21) Appl. No.: 10/872,069

(22) Filed: Jun. 18, 2004

Related U.S. Application Data
(60) Provisional application No. 60/479,965, filed on Jun. 19, 2003.

(51) Int. Cl. G06K 7/00

(52) U.S. Cl. 235/435

(57) ABSTRACT

A decoding device and method for using same for educational, training and/or recreational purposes. The invention provides a card having a visual representation of an item to be decoded, having one or more characters, a pattern strip, a decoding key, wherein the decoding key comprises a plurality of decoding sub-keys, and a legend. Through use of the decoding key, colors in the pattern strip are identified in the proper order, with each color corresponding to a character in the legend. By assembling the decoded characters, the user is able to determine the item to be decoded. Such a system and method enhances the user's ability to retain visually complex materials through the decoding, “picturing” and then retaining in memory multiple elements at once. This is useful for a variety of learning activities, including memorization of “sight words”, i.e. words following no particular phonic or rule pattern (e.g. one, the), mathematical expressions and other random patterns. It is especially effective for those users who have difficulty retaining information visually and/or in sequence.

### CROSS REFERENCE TO RELATED APPLICATION

This application claims the benefit and priority of U.S. provisional patent application No. 60/479,965, filed Jun. 19, 2003, the disclosure of which is incorporated by reference herein in its entirety.

### BACKGROUND OF THE INVENTION

1. Field of the Invention

The present invention relates to a decoding system and method and more particularly to a system and method used to decode words, patterns of letters, numbers and/or symbols. Use of the system and method provide significant educational and/or training benefits to the user due to the skills mastered through use of the system and method.

2. Description of the Prior Art

Current clinical research reaffirms that poor readers have failed to develop the occipito-temporal “storage area” of the brain, and are thus forced to puzzle over each word they read as if encountering it for the first time, slowing the reading process, reducing fluency and lowering comprehension. This skill, namely turning words into “sight words”, is infrequently addressed in most learning materials available today. Thus, there is a need for a system and method whereby poor readers can improve their decoding abilities.

Various means of encoding and decoding letters, numbers and symbols exist. However decoding the 26 letters of the alphabet, for example, may require memorizing a matching set of 26 other letters, numbers or symbols, rendering such a decoding system difficult or unworkable for a user.

Performing what amounts to a magic trick has proven to be a powerful motivator for encouraging users, especially children, to engage in the repeated practice necessary to improve their decoding abilities, including as related to sight words.

There is therefore a need for a system and method that allows users to perform, a magic trick by secretly decoding words or other multi-character expressions, a letter at a time, in order, and retain them in memory, thereby:

a. Learn to build and retain mental pictures of entire words.

b. Strengthen visual memory and increase digit span. (Digit span refers to the number of letters or numbers a user can retain in visual memory at one time.)

c. Increase reading fluency by enlarging the user's sight word vocabulary.

### SUMMARY OF THE INVENTION

These and other objects and advantages of the present invention are achieved by providing a system and method that make use of a card having a visual representation of an item to be decoded, wherein the item to be decoded is represented by one or more characters, a pattern strip, wherein said pattern strip is comprised of a plurality of segments and wherein at least one of the plurality of segments corresponds to each character, a decoding key, wherein the decoding key comprises a plurality of decoding sub-keys, and wherein at least one of the decoding sub-keys corresponds to at least one of the plurality of segments, and a legend, wherein the legend comprises a plurality of elements corresponding to the plurality of segments. The system and method may make use of a container for receiving the card, wherein the item to be decoded and the pattern strip are visually presented on the card and the decoding key and legend are visually presented on the container. The system and method may alternatively make use of a card that has a first face and a second face, and wherein the item to be decoded is visually presented on the first face and the pattern strip, decoding key and legend are visually presented on the second face. According to another embodiment of the present invention, at least two of the plurality of decoding sub-keys correspond to a single segment. Further, according to another embodiment of the present invention, the decoding key is located on a member distinct from the card. Still further, according to another embodiment of the present invention, the plurality of elements comprise at least one of a system of letters of an alphabet, a system of numbers, a system of icons, a system of word syllables and a system of symbols. Further, according to another exemplary embodiment of the present invention, the item to be decoded comprises at least one of a word, formula, syllable, equation, picture, illustration, photograph and other visual element. Finally, according to another embodiment of the present invention, the card includes at least three edges and wherein the pattern strip is visually located on at least two of the at least three edges.

### DESCRIPTION OF THE DRAWINGS

These and other advantages of the present invention will be readily understood with reference to the following specification and attached drawing wherein:

FIG. 1 illustrates an envelope in accordance with one embodiment of the present invention;

FIG. 2a illustrates a card with a single word containing no repeating letters;

FIG. 2b illustrates the card shown in FIG. 2a placed inside of the envelope shown in FIG. 1;

FIG. 3 illustrates a method according to one embodiment of the present invention;

FIG. 4a illustrates a card with single word containing at least one repeating letter.

FIG. 4b illustrates the card shown in FIG. 4a placed inside of the envelope shown in FIG. 1.

FIG. 5a illustrates a variant of the card shown in FIG. 2a;

FIG. 5b illustrates the card shown in FIG. 5a placed inside of envelope shown in FIG. 1;

FIG. 6a illustrates a first side of a card according to another embodiment of the present invention; and

FIG. 6b illustrates a second side of a card according to another embodiment of the present invention.

### DETAILED DESCRIPTION

Use of this invention develops and enhances the user's ability to retain visually complex materials by encouraging him/her to decode, “picture” and then retain in memory multiple elements at once. This is useful for a variety of reasons, including memorization of “sight words”, i.e. words following no particular phonic or rule pattern (e.g. one, the), mathematical expressions and other random patterns. The present invention is especially effective for those users who have difficulty retaining information visually and/or in sequence.

The system of the present invention comprises two components, namely a decoding component and “item to be decoded” component. The “item to be decoded” component is decoded through the use of various pieces of information contained on or associated with the decoding component. The user of the present invention assembles the results of the decoding operation in order to determine the “item to be decoded” contained on the “item to be decoded” component.

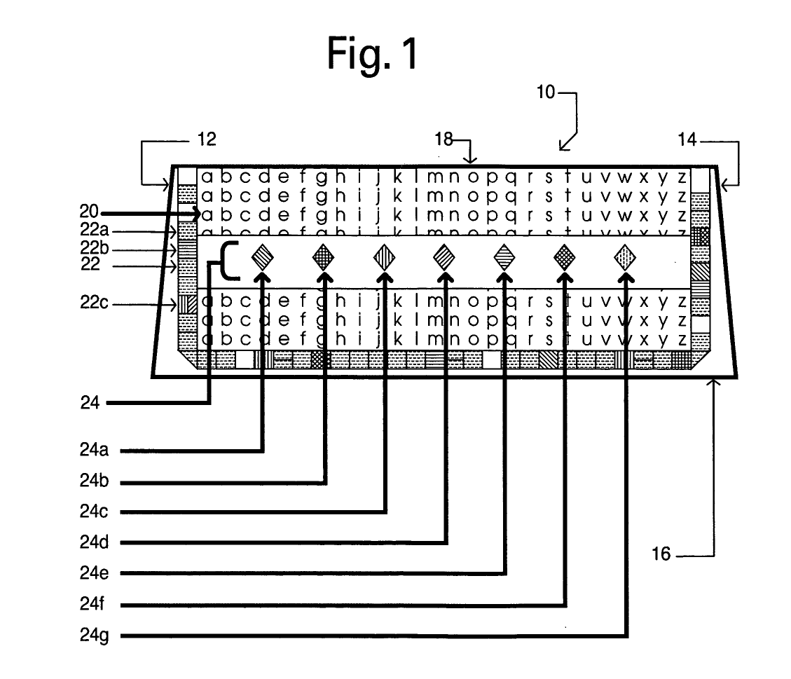

FIG. 1 depicts a decoding component, envelope 10, according to one embodiment of the present invention. Envelope 10 is preferably sealed along a left side 12, a right side 14, and a bottom edge 16. A top edge 18 is preferably not sealed. Any combination of sealed sides and/or edges 12, 14, 16 and 18 may be used with the present invention, as long as at least one side or edge 12, 14, 16, 18 is not sealed to allow for insertion of a card 30, as will be described hereinafter.

Positioned on the envelope 10 is a legend 20, a decorative pattern strip 22 and a decoding key 24. Legend 20 comprises a pattern of elements, e.g. letters, numbers, icons, word syllables, symbols and/or any other predetermined set of elements. The legend 20 includes a set of all the letters, numbers, icons, word syllables, symbols and/or any other predetermined set of elements that may appear in any of the words, letter or number patterns in any of the items to be decoded. The letters, numbers, icons, word syllables, symbols and/or any other predetermined set of elements may appear in alphabetical and/or numerical order, in a random order, as words or otherwise. In the embodiment depicted in FIG. 1, the legend 20 comprises the 26 letters of the English alphabet in alphabetical order. The legend 20 is used in decoding the “item to be decoded”. Specifically, one or more of the elements in legend 20 comprise the “item to be decoded.”

The decorative pattern strip 22 comprises segments of various colors, for example segments 22a, 22b and 22c, and appears to be a decorative motif because of its visual similarity to the coded pattern strip 40 (described later). Consequently, the decorative pattern strip 22 obfuscates that the coded pattern strip 40 contains information used in the decoding system and method. In the embodiment of FIG. 1, the decorative pattern strip 22 is along the left side 12, right side 14 and bottom edge 16.

The decoding key 24 is a mnemonic aid disguised as a “design” motif, incorporating colors used in the coded pattern strip 40 (discussed later) and denoting a predetermined chronological sequence in which the characters of the “item to be decoded” are to be decoded. The decoding key 24 comprises sub-keys 24a, 24b, 24c, 24d, 24e, 24f and 24g. In the embodiment depicted in FIG. 1, the first sub-key 24a is green, the second sub-key 24b is yellow, the third sub-key 24c is red, the fourth sub-key 24d is brown, the fifth sub-key 24e is blue, the sixth sub-key 24f is orange, and the seventh sub-key is violet. The number of sub-keys included in decoding key 24 may vary based on constraints for a particular application, including the number of elements to be decoded. While the decoding key 24 is depicted on envelope 10 in FIG. 1, it should be appreciated that the decoding key 24 may be included separate from the envelope 10, such as on a card, packaging or otherwise.

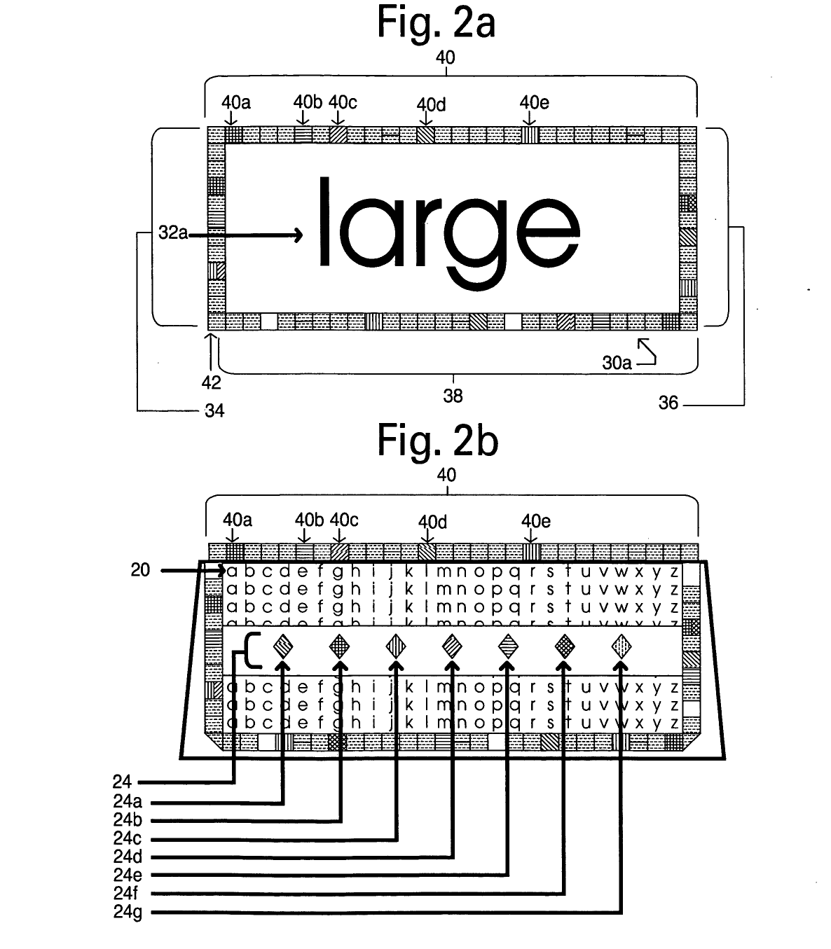

FIG. 2a depicts a card 30a according to one embodiment of the present invention. The card 30a contains an item to be decoded 32a, a coded pattern strip 40 and a second decorative pattern strip 42. The item to be decoded 32a may be a word or words, formulas, syllables, equations, pictures, illustrations, photographs, numerical expressions or any other visual elements. In the card 30a of FIG. 2a, the item to be decoded 32a is the word “large”. The second decorative pattern strip 42 appears along one or more of a left side 34, a right side 36, and a bottom edge 38 of card 30a. The second decorative pattern strip 42 is similar to decorative pattern strip 22 in FIG. 1 in that the second decorative pattern strip 42 is comprised of segments of various colors.

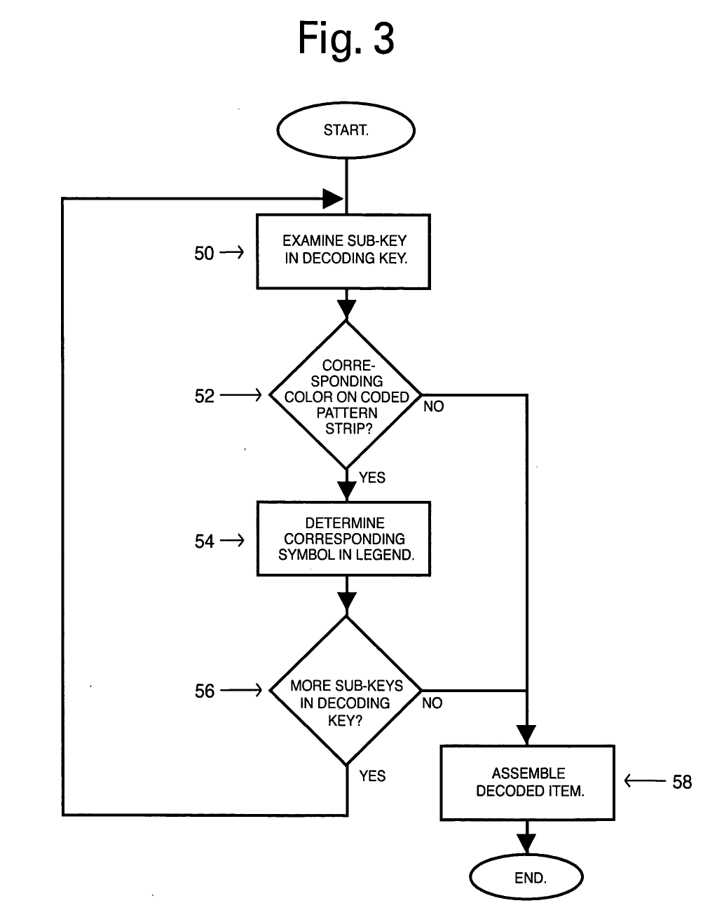

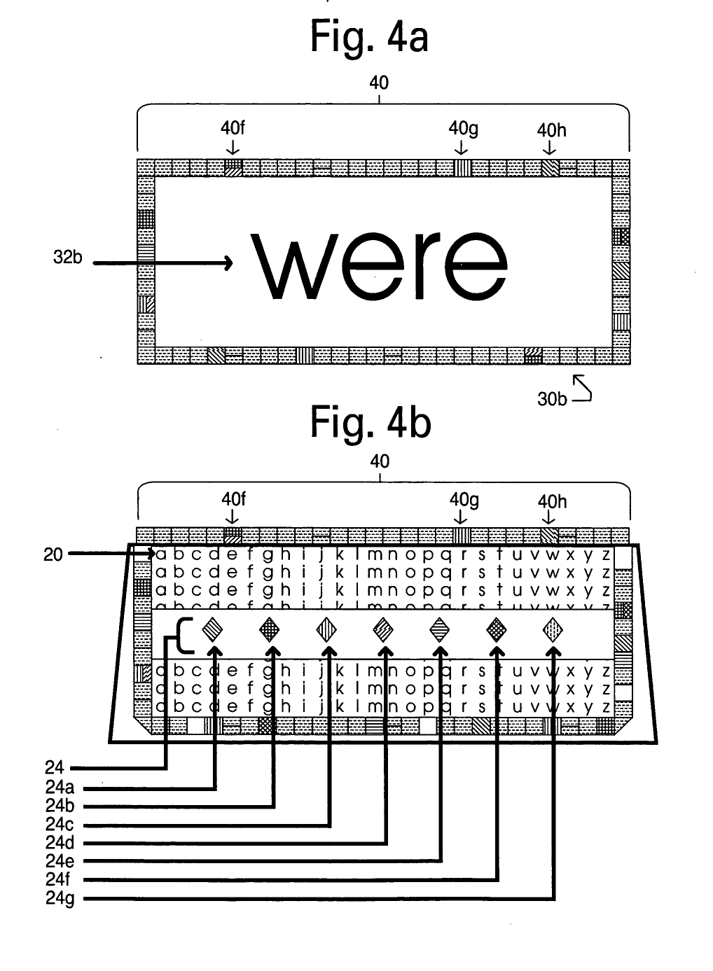

In the embodiment depicted in FIG. 2a, the coded pattern strip 40 is along the top edge of card 30a. Segments in shades of gray or other preselected “null value” colors align with and correspond to those letters/numbers which do not appear in the item to be decoded 32a. As will be discussed with reference to FIG. 3, certain segments in the coded pattern strip 40, e.g. 40a, 40b, 40c, 40d, and 40e, are not “null value” colors but rather correspond to the decoding key 24, and, consequently, to the item to be decoded 32a. The coded pattern strip 40 is unique to each item to be decoded 32, wherein, as explained with reference to FIG. 2b, each exposed color segment aligns with one letter, number or symbol of the legend 20 when the card 30 is placed into the envelope 10.

FIG. 2b depicts card 30a of FIG. 2a when placed inside of envelope 10 of FIG. 1. In the embodiment of FIG. 2b, the coded pattern strip 40 of remains visible when card 30a is placed inside of envelope 10. This may be accomplished, for example, by making the card 30a taller than the envelope 10 or by including an aperture (not shown) in envelope 10 through which the coded pattern strip 40 is visible. For convenience, the coded pattern strip 40 may be duplicated on one or more of the sides and edges of card 30a so that, when inserted in envelope 10, the coded pattern strip 40 is visible, regardless of the orientation in which card 30a is inserted.

Once placed inside of envelope 10, the user will be able to perform the “magic trick,” i.e. identify and/or read the content of the card 30a despite the item to be decoded 32 being concealed from the user. Each relevant color segment in the coded pattern strip 40 is identified by the user in the predetermined chronological order as defined by the decoding key 24 and its aligned character, e.g. letter, in the legend 20 read, thus revealing to the user the item to be decoded 32. Letters aligned with segments in shades of gray or other preselected “null value” colors are not relevant to the item to be decoded 32.

Consequently, one or more of the colors of the decoding sub-keys 24a-24g will appear in the coded pattern strip 40 for use in decoding the item to be decoded 32; other colors in the coded pattern strip 40 are not relevant. This allows for a system and method in which a one-to-one correspondence of the number of colors and the number of elements in the legend 20. For example, if a one-to-one correspondence was required for a legend comprising the twenty six letters of the alphabet, twenty six colors would also be required. Because the decoding sub-keys 24a-24g are considered in order, only those segments in the coded pattern strip 40 that correspond to any of the decoding sub-keys 24a-24g must be colored in a relevant color, thereby allowing for a system in which fewer colors are required.

Referring to FIG. 3, a decoding method according to the present invention is disclosed. Initially, the user examines the first sub-key 24a (FIG. 2b) to determine its color (block 50). The user then refers to the coded pattern strip 40 to determine whether there is a segment with the corresponding color (block 52). If there is a segment with the corresponding color, then the user refers to the legend 20 to determine the corresponding symbol in the legend 20 (block 54). In the embodiment depicted in FIG. 2b, the corresponding symbol in legend 20 is the letter immediately below the corresponding color. After determining a first corresponding symbol, the user determines if there are additional sub-keys in the decoding key 24 to be analyzed (block 56). If there is at least one additional sub-key in the decoding key 24 to be analyzed, the user again examines the sub-key in the decoding key (block 50), refers to the coded pattern strip 40 to determine whether there is a corresponding color (block 52) and, if so, the corresponding symbol (block 54). If there is no corresponding color in the top edge 40 (block 52) or there are no additional sub-keys in decoding key 24 (block 56), then the user has decoded the item and assembles the decoded item (block 58).

It should be appreciated that those skilled in the art may implement the method described with reference to FIG. 3 as a series of machine-readable instructions such that the method is practiced on a computer. For example, each of the envelope 10, legend 20, decorative pattern strip 22, decoding key 24, card 30, item to be decoded 32 and coded pattern strip 40 may be visually presented on a display whereby the user may utilize one or more input devices, e.g. mouse, keyboard, pointing device, etcetera, to practice the method.

With reference to FIG. 2b, as an example, the user first looks at the decoding key 24, which, in the embodiment depicted in FIG. 2b, comprises seven sub-keys 24a-24g. The first sub-key 24a is colored green (block 50, FIG. 3). In examining the coded pattern strip 40 of the card 30a, it is determined that there is a green segment 40d on the card 30a (block 52, FIG. 3). The green segment 40d corresponds to the letter “I” in the legend 20 on envelope 10, i.e. the letter “I” is adjacent to the green segment 40d (block 54, FIG. 3). In looking at the decoding key 24, it is determined that there are additional sub-keys (block 56, FIG. 3). The second sub-key 24b is colored yellow (block 50, FIG. 3). In examining the coded pattern strip 40 of the card 30a, it is determined that there is a yellow segment 40a on the card 30 (block 52, FIG. 3). The yellow segment 40a corresponds to the letter “a” in the legend 20 on envelope 10 (block 54, FIG. 3). In looking at the decoding key 24, it is determined that there are additional sub-keys (block 56, FIG. 3). The third sub-key 24c is colored red (block 50, FIG. 3). In examining the coded pattern strip 40 of the card 30a, it is determined that there is a red segment 40e on the card 30a (block 52, FIG. 3). The red segment 40a corresponds to the letter “r”, in the legend 20 on envelope 10 (block 54, FIG. 3). In looking at the decoding key 24, it is determined that there are additional sub-keys (block 56, FIG. 3). The fourth sub-key 24d is colored brown (block 50, FIG. 3). In examining the coded pattern strip 40 of the card 30a, it is determined that there is a brown segment 40c on the card 30a (block 52, FIG. 3). The brown segment 40c corresponds to the letter “g” in the legend 20 on envelope 10 (block 54, FIG. 3). In looking at the decoding key 24, it is determined that there are additional sub-keys (block 56, FIG. 3). The fifth sub-key 24e is colored blue (block 50, FIG. 3). In examining the coded pattern strip 40 of the card 30a, it is determined that there is a blue segment 40b on the card 30a (block 52, FIG. 3). The blue segment 40b corresponds to the letter “e” in the legend 20 on envelope 10 (block 54, FIG. 3). In looking at the decoding key 24, it is determined that there are additional sub-keys (block 56, FIG. 3). The sixth sub-key 24b is colored orange (block 50, FIG. 3). In examining the coded pattern strip 40 of the card 30a, it is determined that there is not an orange segment on the card 30a (block 52, FIG. 3). Thus, the decoding of the word is complete and the user assembles the decoded item (block 58, FIG. 3). Thus, the item to be decoded 32a on the card 20 is assembled as “l-a-r-g-e”, i.e. “large.” The user may confirm that the item to be decoded 32a was properly decoded by removing the card 30a from the envelope 10 and analyzing the item to be decoded 32a.

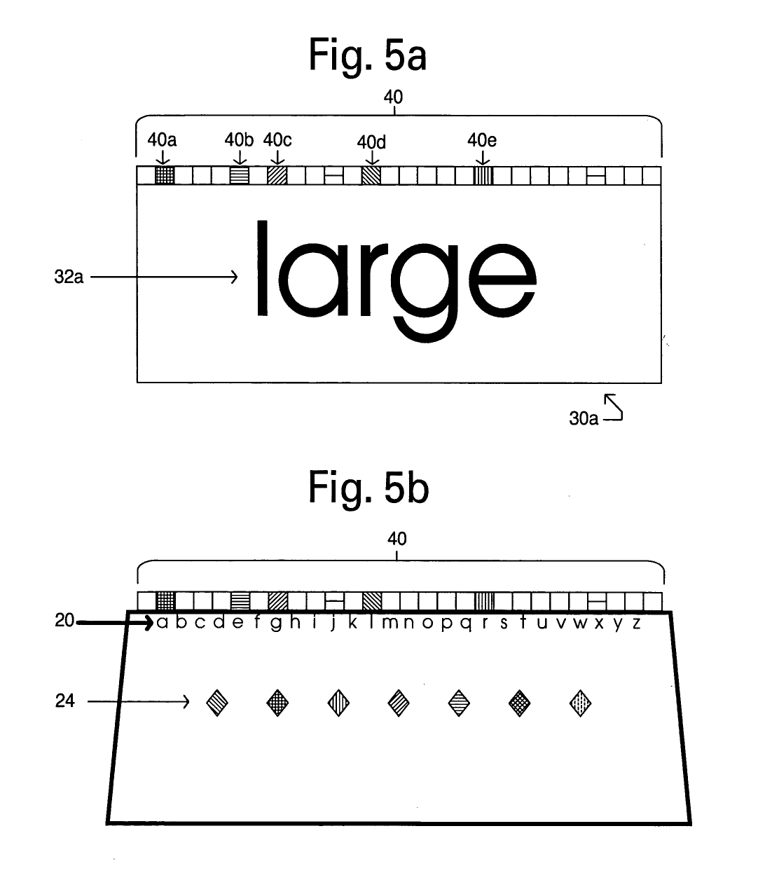

In another embodiment of the present invention, a single segment within the coded pattern strip 40 may correspond to multiple sub-keys of decoding key 24. Specifically, any of the colored segments in the coded pattern strip 40 may be further divided so that any letter may be referenced multiple times. For example, with reference to card 30b depicted in FIG. 5a, an item to be decoded 32b is the word “were”. Because the letter “e” appears twice in the item to be decoded 32b, but only appears once in the legend 20, the color segment in the coded pattern strip 40 on the card 30b that aligns with the letter “e” on the envelope 10, i.e. segment 40f, is divided in two: one half of which is yellow, indicating that “e” is the second letter to be read, and one half which is brown, indicating “e” is also the fourth letter to be read.

Through the use of such an arrangement whereby characters may be used multiple times in decoding an item to be decoded 32, the number of colors in the decoding key 24, and therefore the length of the item to be decoded 32, e.g. words, mathematical expressions, etcetera, may be quite large.

In FIG. 5a, card 30a is illustrated with all non-essential decorative motifs removed for clarity. In FIG. 5b, card 30a is illustrated inserted into the envelope 10 with all non-essential decorative motifs removed. Remaining are: the item to be decoded 32a, the relevant segments 40a, 40b, 40c, 40d, and 40e from the coded pattern strip 40 on card 30a; the legend 20, e.g. the twenty six letters of the alphabet, on envelope 10, each aligned with a particular color code segment in the coded pattern strip 40; and the decoding key 24 indicating the chronological order of the colors to be used in decoding the item to be decoded 32a. It is clear that without the camouflaging benefits offered by the decorative elements, e.g. decorative pattern strip 22 and “null values” in the coded pattern strip 40, the operation of the magic trick is more easily detected.

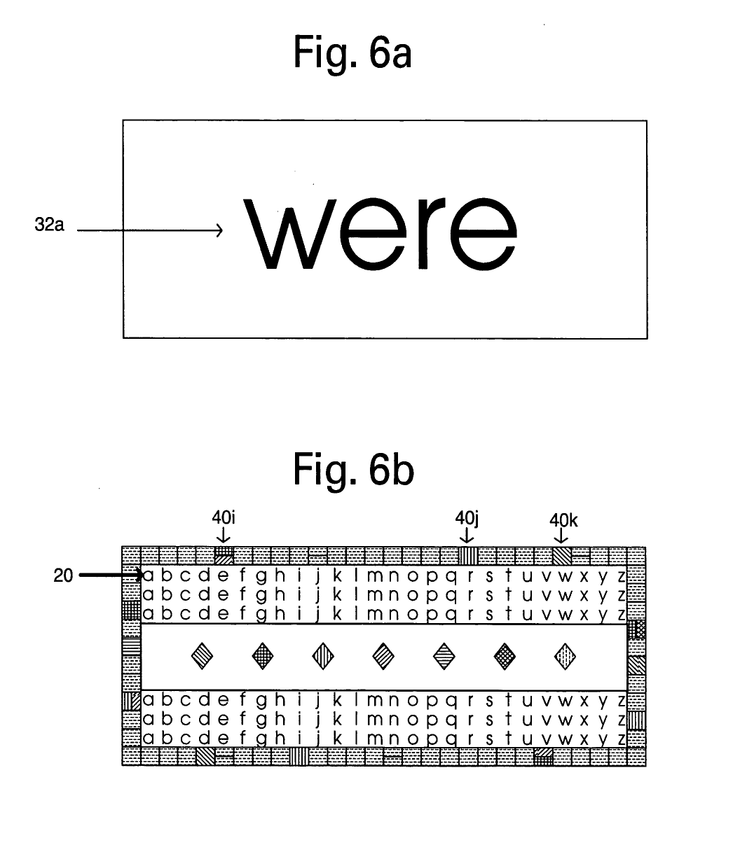

In FIGS. 6a and 6b, another exemplary embodiment of the present invention is disclosed. Rather than including the item to be decoded 32 and the coded pattern strip 40 on the card 30, and the legend 20 and the decoding key 24 on the envelope 10, the embodiment of FIGS. 6a and 6b makes use of a single card 30 and does not require an envelope 10. A first side of card 30c includes the item to be decoded 32a. A second side of card 30c includes the legend 20, the decoding key 24 and the coded pattern strip 40. Rather than obscuring the item to be decoded 32 from the user by inserting the card 30 into envelope 10, the user simply does not refer to the first side of card 30c that includes the item to be decoded 32a. By referencing the second side of card 30c, the user may decode the item to be decoded 32a by examining each of the sub-keys within decoding key 24, determine the corresponding color on the coded pattern strip 40, determine the corresponding symbol in the legend 20 and, when finished, assemble the item to be decoded 32a. The user may then reference the first side of card 30c to determine if the item to be decoded 32a was properly decoded.

With respect to the item to be decoded 32, it should be appreciated that numerous items are possible. As previously stated, the item to be decoded 32 may be a word or words, pictures, a numerical expression or any other visual element. As an example, if the item to be decoded is a picture of a dog, the decoding sub-keys 24a, 24b and 24c would map to segments on the coded pattern strip 40 that correspond to the letters d-o-g in the legend 20. Similarly, if the item to be decoded is a picture of a child running, the decoding sub-keys 24a, 24b, 24c, 24d, 24e, 24f and 24g would map to segments on the coded pattern strip 40 that correspond to the letters r-u-n-n-i-n-g in the legend 20. Thus, the item to be decoded 32 is not required to be comprised of letters or numbers. Rather, the item to be decoded 32 must simply be an item that can be expressed in terms of a different map of characters (letters, numbers, symbols, etcetera).

Obviously, many modifications and variations of the present invention are possible in light of the above teachings, including implementation on a computer. Thus, it is to be understood that, within the scope of the appended claims, the invention may be practiced otherwise than as specifically described above.

What is claimed and desired to be covered by a Letters Patent is as follows:

We claim:

1. A system for decoding comprising:
a card having a visual representation of an item to be decoded, wherein the item to be decoded may be expressed as one or more characters;
a pattern strip, wherein said pattern strip is comprised of a plurality of segments and wherein at least one of the plurality of segments corresponds to each character;
a decoding key, wherein the decoding key comprises a plurality of decoding sub-keys, and wherein at least one of the plurality of segments corresponds to at least one of the decoding sub-keys; and
a legend, wherein the legend comprises a plurality of elements corresponding to the plurality of segments.

2. The system of claim 1 further comprising a container for receiving the card, wherein the item to be decoded and the pattern strip are visually presented on the card and the decoding key and legend are visually presented on the container.

3. The system of claim 1 wherein the card has a first face and a second face, and wherein the item to be decoded is visually presented on the first face and the pattern strip, decoding key and legend are visually presented on the second face.

4. The system of claim 1 wherein at least two of the plurality of decoding sub-keys correspond to a single element in the legend.

5. The system of claim 1 wherein the decoding key is located on a member distinct from the card.

6. The system of claim 1 wherein the plurality of elements comprise at least one of a system of letters of an alphabet, a system of numbers, a system of icons, a system of word syllables and a system of symbols.

7. The system of claim 1 wherein the card includes at least three edges and wherein the pattern strip is visually located on at least two of the at least three edges.

8. The system of claim 1 wherein the item to be decoded comprises at least one of a word, formula, syllable, equation, picture, illustration, photograph and other visual element.

9. A decoding method comprising the steps of:
examining a sub-key associated with a decoding key, wherein the decoding key comprises at least one sub-key;
determining whether a segment in a coded pattern strip corresponds to the sub-key; and
identifying a symbol that corresponds to the segment that corresponds to the sub-key.

10. The method of claim 9 further comprising assembling each symbol into an expression.

11. The method of claim 9 wherein the expression comprises at least one of a word, formula, syllable, equation, picture, illustration, photograph and other visual element.

12. A decoding system comprising:
means for examining a sub-key associated with a decoding key, wherein the decoding key comprises at least one sub-key;
means for determining whether a segment in a coded pattern strip corresponds to the sub-key; and
means for identifying a symbol that corresponds to the segment that corresponds to the sub-key.

13. The decoding system of claim 12 further comprising means for assembling each symbol into an expression.

14. The decoding system of claim 12 wherein the expression comprises at least one of a word, formula, syllable, equation, picture, illustration, photograph and other visual element.

15. A system for decoding comprising:
a card having a visual representation of an item to be decoded, wherein the item to be decoded may be expressed as one or more characters;
a pattern strip, wherein said pattern strip is comprised of a plurality of segments and wherein at least one of the plurality of segments corresponds to each character;
a decoding key, wherein the decoding key comprises a plurality of decoding sub-keys, and wherein at least one of the plurality of segments corresponds to at least one of the decoding sub-keys;
a legend, wherein the legend comprises a plurality of elements corresponding to the plurality of segments; and
a container for receiving the card, wherein the item to be decoded and the pattern strip are visually presented on the card and the decoding key and legend are visually presented on the container.

16. The system of claim 15 wherein at least two of the plurality of decoding sub-keys correspond to a single segment.

17. The system of claim 15 wherein the plurality of elements comprise at least one of a system of letters of an alphabet, a system of numbers, a system of icons, a system of word syllables and a system of symbols.

18. The system of claim 15 wherein the card includes at least three edges and wherein the pattern strip is visually located on at least two of the at least three edges.

19. The system of claim 15 wherein the item to be decoded comprises at least one of a word, formula, syllable, equation, picture, illustration, photograph and other visual element.

20. The system of claim 15 wherein the card has a first side and a second side, and wherein the item to be decoded is on the first side and the pattern strip is on the second side.

21. A system for decoding comprising:
a card having a visual representation of an item to be decoded, wherein the item to be decoded may be expressed as one or more characters;
a pattern strip, wherein said pattern strip is comprised of a plurality of segments and wherein at least one of the plurality of segments corresponds to each character;
a decoding key, wherein the decoding key comprises a plurality of decoding sub-keys, and wherein at least one of the plurality of segments corresponds to at least one of the decoding sub-keys; and
a legend, wherein the legend comprises a plurality of elements corresponding to the plurality of segments, wherein the card has a first face and a second face, and wherein (a) the item to be decoded is visually presented on the first face and (b) the pattern strip, decoding key and legend are visually presented on the second face.

22. The system of claim 21 wherein at least two of the plurality of decoding sub-keys correspond to a single segment.

23. The system of claim 21 wherein the plurality of elements comprise at least one of a system of letters of an alphabet, a system of numbers, a system of icons, a system of word syllables and a system of symbols.

24. The system of claim 21 wherein the card includes at least three edges and wherein the pattern strip is visually located on at least two of the at least three edges.

25. The system of claim 21 wherein the item to be decoded comprises at least one of a word, formula, syllable, equation, picture, illustration, photograph and other visual element.
